(19) United States
(12) Patent Application Publication
(10) Pub. No.: US 2023/0085925 A1
(43) Pub. Date: Mar. 23, 2023

(54) CARTRIDGE STRUCTURE

(71) Applicant: BESPOKEN SPIRITS, INC., Menlo Park, CA (US)

(72) Inventors: Martin JANOUSEK, Mountain View, CA (US); Arne BALLANTINE, Palo Alto, CA (US); Thomas LORINCZ, Hollister, CA (US)

(21) Appl. No.: 17/905,553

(22) PCT Filed: Mar. 4, 2021
(86) PCT No.: PCT/US2021/020860

§ 371 Date: Sep. 2, 2022

Related U.S. Application Data
(60) Provisional application No. 62/985,695, filed on Mar. 5, 2020.

(51) Int. Cl. C12H 1/22; C12G 3/07; C12H 1/07

(52) U.S. Cl. CPC C12H 1/22; C12G 3/07; C12H 1/063

(57) ABSTRACT

Systems, methods, and devices of the various embodiments may enable maturing of spirits and other products. Various embodiments may provide an in-line spirits processor in which the spirits being matured are not stirred, but rather continuously circulated during maturing. Various embodiments may provide an in-line spirits processor in which, wood additives, such as micro-staves, chips, powders, etc., as may be added in a cartridge (or canister) that is in-line with a spirit flow.

### SUMMARY

This application claims the benefit of priority to U.S. Provisional Application No. 62/985,695 entitled “Cartridge Structure” filed on Mar. 5, 2020, the entire contents of which are hereby incorporated by reference for all purposes.

### BACKGROUND

Standard processes for maturing spirits or other products typically involve the distilled spirits or other products being placed into a barrel, such as an oak barrel, and kept in contact with the inner surface of that barrel for a period of time. In these standard processes, the barrel itself may be treated, such as by charring, in an to attempt to deliver a desired flavor to the spirits or other products. Attempts to accelerate the standard processes have been made, but these attempts have not been shown to consistently accelerate the maturation process such that a controlled result may be achieved.

### SUMMARY

Systems, methods, and devices of the various embodiments may enable maturing of spirits and other products. Various embodiments may provide an in-line spirits processor in which the spirits being matured are not stirred, but rather continuously circulated during maturing. Various embodiments may further provide for air supply to the spirits being matured, heating of the spirits being matured, and mixing of wood with the spirits being matured during the maturing process. Various embodiments may provide a cartridge structure for spirits maturing.

Various embodiments may provide an in-line spirits processor in which, wood additives, such as micro-staves, chips, powders, etc., may be added in a cartridge (or canister) that is in-line with a spirit flow. In an embodiment in-line spirits processor, spirits processing may be performed after the spirits pass through the cartridge. Spirits processing may be continued while monitoring critical parameters with the recirculation of the liquid being ended and product removed when a desired end-point is reached. In various embodiments, an in-line spirits processor may include a plurality of cartridges with different wood additive inserts (e.g., different micro-stave inserts) wherein these wood additives (e.g., the micro-staves) have differences in toasting, charring, wood pre-treatments (e.g., soaking) and/or types of wood.

Various embodiments may include an in-line spirits processor, comprising: a vessel configured to hold spirits to be matured; a pump configured to recirculate a flow of the spirits from and to the vessel; and one or more cartridges in-line with the flow of spirits to be matured, at least one of the one or more cartridges including wood additives therein.

Various embodiments may include a method for maturing a flow of spirits, comprising: providing spirits to be matured into a vessel of an in-line spirits processor; and recirculating a flow of the spirits from and to the vessel through one or more cartridges, at least one of the one or more cartridges including wood additives therein.

### BRIEF DESCRIPTION OF THE DRAWINGS

The accompanying drawings, which are incorporated herein and constitute part of this specification, illustrate example aspects of the claims, and together with the general description given above and the detailed description given below, serve to explain the features of the claims.

FIG. 1 illustrates an in-line spirits processor configured to support recirculating a flow with a plurality of cartridges arranged where the air to spirits ratio may be controlled and the mixture may be recirculated according to various embodiments.

FIG. 2 is a graph of a control metric from a plurality of sensors by which the end-point of the process may be measured for and determined according to various embodiments.

FIG. 3 is a process flow diagram illustrating a method for maturing a flow of spirits in accordance with various embodiments.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments relate to the process of maturing spirits or other products wherein the distilled spirits or other products are placed into a container such as an oak barrel and kept in contact with the inner surface of that barrel for a period of time. In the standard process, the barrel may be treated with a process such as charring to deliver desired flavors to the product.

Some methods attempt to accelerate the maturing of sprits through various means. In one method, heating in the presence of light is used; in another method, ultrasonic energy is introduced. Methods of heating, steam injection or application of pressure may also be used. None of these methods have been shown to consistently accelerate the maturation process such that a controlled result may be achieved.

As used herein the term “matured” may refer to spirits that have been transitioned from raw (or unrefined) spirits toward a state having one or more selected profile characteristics, such as aroma, color, flavor, etc. Such transition may be referred to as “maturation” or “maturing”. Typically, such maturation of spirits has been achieved by typical barrel-based aging processes. Matured spirits may also sometimes be referred to as “aged spirits.” As discussed herein, a matured spirit (or maturation or maturing) may be achieved in different time frames, and the term matured (or maturation or maturing) as used in reference to the various embodiments is not intended to imply any specific time period and is not intended to limit the various embodiments or claims to any specific time period.

Systems, methods, and devices of the various embodiments may enable maturing of spirits and other products. Various embodiments may provide an in-line spirits processor in which the spirits being matured are not stirred, but rather continuously circulated during maturing. Various embodiments may further provide for air supply to the spirits being matured, heating of the spirits being matured, and mixing of wood with the spirits being matured during the maturing process.

In an embodiment in-line spirits processor, wood additives, such as micro-staves, chips, powders, etc., may be added in a cartridge (or canister) that is in-line with a spirit flow. In this manner, spirits may flow through the cartridge (canister) and over the wood additives therein before exiting the canister.

As used herein, the term “micro-stave” may refer to a smaller piece of wood rendered (e.g., cut, chopped, chiseled, etc.) from a larger piece of wood such that resulting smaller piece of wood (i.e., the micro-stave) has cubic dimensions of equal to or less than approximately 20 mm×20 mm×100 cm, but greater than approximately 0.05 mm×0.05 mm×0.05 mm. Said another way, a micro-stave may be a processed (e.g., e.g., cut, chopped, chiseled, etc.) wood structure that completely fits within a rectangular volume that is 20 mm×20 mm×100 cm while not completely fitting within a rectangular volume that is 0.05 mm×0.05 mm×0.05 mm. Micros-staves may be rendered (e.g., cut, chopped, chiseled, etc.) from a larger piece of wood such that the volume and surface area of the wood piece that is the micro-stave is controlled to achieve a selected volume and surface area thereby enabling controlled and uniform extraction of the wood components by a spirit. While referred to herein using the term “micro” as part of “micro-stave” the term “micro” is not used in its metric system prefix meaning as part of “micro-stave”, but is rather a descriptor indicating that the “micro-staves” as described herein are smaller than staves used in typical wine or spirit barrels which are often on the order of 10 mm×60 mm×1000 mm or larger.

As used herein, the term “toasted” refers to a state of a wood product, such as a micro-stave, in which the wood product has been exposed to heat thereby causing thermal decomposition of the cellulose, hemicellulose and lignin in the wood forming the wood product without any resulting visible char accumulation on the external surface of the wood. Toasted wood products may have been heated such that some decomposition of the wood surface occurred without combustion reactions at the surface of the wood occurring to result in visible carbon residues (e.g., char layers). Toasting as described herein may be performed such that the entire volume of the wood is transformed and decomposed uniformly. Toasting may be done in an oven and may take a time period from minutes to hours to achieve a toasted state of a wood product.

As used herein, the term “charred” refers to a state of a wood product, such as a micro-stave, in which the wood product has been exposed to heat thereby causing thermal decomposition of the cellulose, hemicellulose and lignin in the wood to at least a point where visible char accumulates on the external surface of the wood.

Charred wood products may have been heated such that some combustion reactions occurred at the surface of the wood resulting in visible carbon residues (e.g., char layers). Such resulting visible carbon residues (e.g., char layers) may be as thin as only a few microns (e.g., 2 microns) thick on the surface of the charred wood product. At least on surface of a wood product need not show visible carbon residues (e.g., charring) for the wood product to be considered a charred wood product, such that as long as a portion of the surface of the wood product is shows visible carbon residues (e.g., charring) the wood product is a charred wood product. In contrast, a toasted wood product may show no visible carbon residues (e.g., charring). Charring as described herein may be performed such that there is a gradient in wood transformation and decomposition due to very high temperatures at the surface that is being charred. Charring may be done with a heat source, such as a gas flame/torch, IR heater, etc., and may take a period of time from seconds to minutes to achieve a charred state of a wood product.

In an embodiment in-line spirits processor, spirits processing may be performed after the spirits pass through the cartridge. Spirits processing may be continued while monitoring critical parameters with the recirculation of the liquid being ended and product removed when a desired end-point is reached.

In various embodiments, an in-line spirits processor may include a plurality of cartridges with different wood additive inserts (e.g., different micro-stave inserts) wherein these wood additives (e.g., the micro-staves) have differences in toasting, charring, wood pre-treatments (e.g., soaking) and/or types of wood.

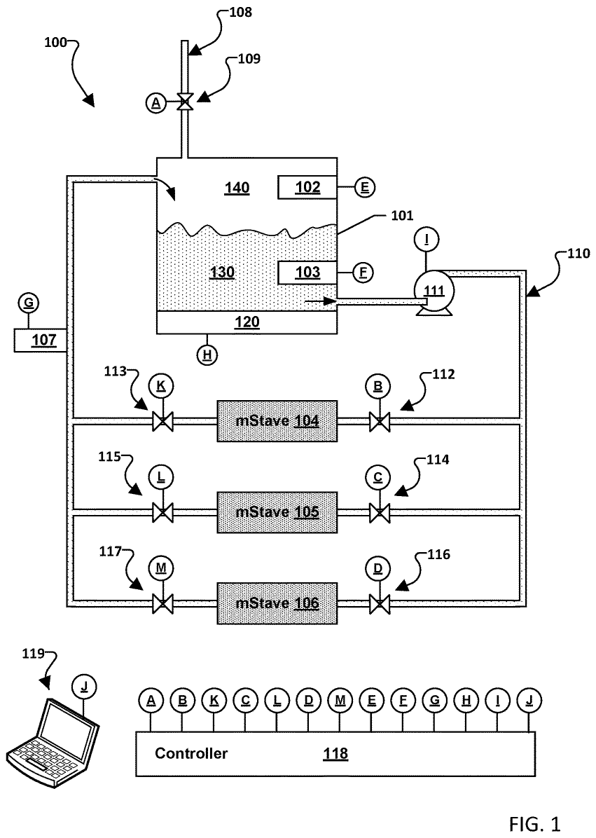

FIG. 1 illustrates an example of an embodiment in-line spirits processor 100 with a plurality of in-line cartridges, such as three cartridges labeled micro-stave (“mStave”) 104, mStave 105, and mStave 106. While three cartridges mStave 104, mStave 105, and mStave 106 are illustrated in the in-line spirits processor 100 of FIG. 1, more or less cartridges may be used in various embodiments, such as one cartridge, two cartridges, four cartridges, five cartridges, more than five cartridges, etc. In various embodiments, the cartridges mStave 104, mStave 105, and/or mStave 106 may be cartridge (or canister) units configured such that a fluid flow may pass into the cartridge (or canister) through a first port (or opening) in the cartridge (or canister), pass over and/or through media (e.g., wood additives, such as micro-staves, chips, powders, etc., other additives, such as charcoal, similar absorbing materials, etc., or other materials) within the cartridge (or canister), and pass out of the cartridge (or canister) through a second port (or opening). In this manner, the cartridges mStave 104, mStave 105, and/or mStave 106 may operate as in-line filters and/or additive stations for the fluid flowing through the cartridges mStave 104, mStave 105, and/or mStave 106.

The in-line spirits processor 100 may include a controller 118 (e.g., a computer or dedicated control logic device or circuit) configured to monitor the conditions of the in-line spirits processor 100 and/or to control the operations of the various elements of the in-line spirits processor 100 to mature a flow of spirits according to various embodiments. The controller 118 may communicate, either directly or indirectly, with other components in the in-line spirits processor 100 and/or with one or more remote control terminals 119. The communications may be via any type wired and/or wireless connections (e.g., labeled by letters A-J of FIG. 1).

The in-line spirit processor 100 may include a vessel 101 (also referred to as a process tank) connected to a circulating pump 111 that may circulate spirits 130 to be matured from the vessel 101, through a piping system 110 to the in-line cartridges (e.g., mStave 104, mStave 105, and/or mStave 106), and from the in-line cartridges (e.g., mStave 104, mStave 105, and/or mStave 106) back to the vessel 101. The pump 111 may be connected to the controller 118 (e.g., via wired and/or wireless connection labeled I of FIG. 1). The operations of the pump 111 (e.g., the changing from an on to off state, changing from off to on state, pumping rate, etc.) may be controlled by the controller 118. The pump 11 circulating the spirits 130 through the piping system 110 may enable the spirts 130 to not be stirred during a maturation process. Rather, instead of being stirred, the spirits 130 may be circulated, continuously or intermittently, during maturing. As such, in-line spirits processors of the various embodiments, such as in-line spirits processor 100 may not include agitation apparatuses, such as a sonicators, motorized mixers, auger arms, etc. in the vessel 101, as no stirring of the spirits 130 may be performed in the various embodiments. The vessel 101 may include air 140 and spirits 130 to be matured. The circulated spirits 130 being moved by the pump 111 through the piping system 110, the in-line cartridges (e.g., mStave 104, mStave 105, and/or mStave 106), and the vessel 101 may be referred to as a spirits flow. The temperature of the vessel 101 may be controlled by heating the vessel by controlling a heater 120 coupled to the vessel 101. The heater 120 may be connected to the controller 118 (e.g., via wired and/or wireless connection labeled H of FIG. 1). The operations of the heater 120 (e.g., the changing from an on to off state, changing from off to on state, temperature, etc.) may be controlled by the controller 118. Air 140 (and/or other gas, such as pure oxygen, etc.) may be added and/or removed from the vessel 101 via an air piping system 108 controlled by a vent control valve 109. The vent control valve 109 may be connected to the controller 118 (e.g., via wired and/or wireless connection labeled A of FIG. 1). The operations of the vent control valve 109 (e.g., opening, closing, etc.) may be controlled by the controller 118.

Sensors may be disposed at various points in the in-line spirits processor 100 to monitor conditions of the spirits 130 to be matured. For example, a sensor 102 may monitor one or more conditions (e.g., temperature, pressure, oxygen level, etc.) of the air 140 in the headspace of the vessel 101. As another example, a sensor 103 may monitor one or more conditions (e.g., temperature, pressure, liquid level, etc.) of the spirits 130 in the vessel 101. As another example, a sensor 107 may monitor one or more conditions (e.g., temperature, pressure, flow rate, etc.) of the spirits flow in the piping system 110. The sensors, such as sensors 102, 103, 107, etc., may output signals to the controller 118 (e.g., via the wired and/or wireless connections labeled E-G of FIG. 1). The controller 118 may monitor the signals output by the sensors, such as sensors 102, 103, 107, etc., and determine states of the in-line spirit processor 100, spirits 130, air 140, and/or flow of spirits based on the monitored signals output by the sensors, such as sensors 102, 103, 107, etc. Additionally, sensor signals may include time measurements, such as counts from an oscillator or other time measurement circuit, and the monitored time that a recipe step has been on-going may be a monitored state of the in-line spirit processor 100, spirits 130, air 140, and/or flow of spirits.

FIG. 1 illustrates the recirculating flow with the plurality of in-line cartridges mStave 104, mStave 105, and mStave 106 arranged where the air 140 to spirits 130 ratio in the vessel 101 is controlled and the mixture (e.g., the flow of spirits) is recirculated. The cartridges mStave 104, mStave 105, and mStave 106 may each be disposed in the piping system between two controllable valves, such as mStave 104 between valves 112 and 113, mStave 105 between valves 114 and 115, mStave 106 between valves 116 and 117, etc., such that each cartridge may be fluidically coupled to, or isolated from, the flow of spirits through the piping system 110 by opening and/or closing the two controllable valves. Each cartridge, mStave 105, mStave 105, and mStave 106, is illustrated as a single in-line cartridge in FIG. 1. However, multiple cartridges, such as two or more cartridges in series and/or parallel, on each line may disposed between the respective controllable valves (e.g., valve pairs 112 and 113, 114 and 115, 116 and 117, etc.). In some embodiments, the valves 109, 112, 113, 114, 115, 116, and 117 may be connected to the controller 118 (e.g., by wired and/or wireless connections labeled by letters A-D and K-M of FIG. 1) and remotely operated by the controller 118 (e.g., opened and/or closed, fully or partially, by signals from the controller 118, etc.).

In some embodiments, one or more remote control terminals 119 may be connected to the controller 118 (e.g., by wired and/or wireless connection labeled J in FIG. 1). The one or more remote control terminals 119 may be computing devices by which an operator may interact with the in-line spirits processor 100. A remote control terminal 119 may send indications of selections of a recipe for the maturation of the spirits 130 to the controller 118. In this manner, the controller 118 may receive a recipe selection from a remote control terminal 119. Alternatively, or additionally, the controller 118 may include its own user interface (e.g., display and/or keypad, etc.) and an operator may directly input a selection of a recipe for the maturation of the spirits 130 to the controller 118 via the user interface. In this manner, the controller 118 may receive a recipe selection. In various embodiments, recipes may be a set of instructions (e.g., defined in hardware, software, and/or firmware, etc.) defining one or more recipe steps for processing the spirits 130 to arrive at a desired process end-point. Desired process end-points may be associated with desired aspects of the spirits, such as color(s), flavor element(s), mouth feel(s), etc. The controller 118 may be configured to control the various elements of the in-line spirits processor 100 (e.g., valves 109, 112, 113, 114, 115, 116, 117, pump 111, heater 120, etc.) based on process parameters determined based on one or more sensors' (e.g., sensors 102, 103, 107) signals according to one or more steps of a recipe to achieve process end-points for the various one or more steps of the recipe and/or an overall process end-point (e.g., a desired spirits 130 maturation) for the overall recipe at the completion of all steps of the recipe.

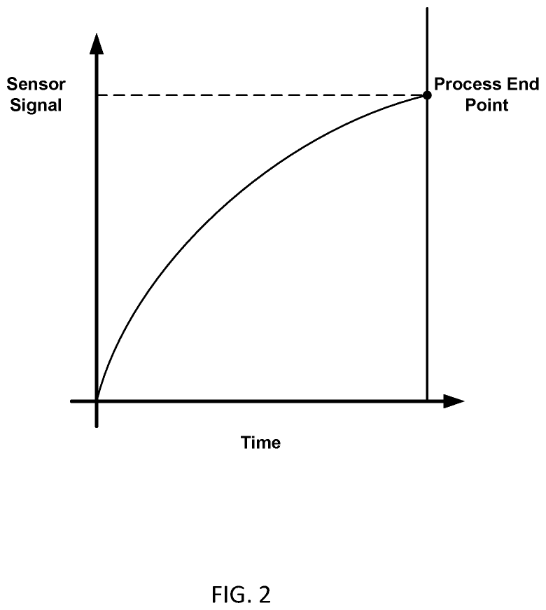

FIG. 2 shows a graph of a control metric from a plurality of sensors (e.g., in the sensors 102, 103 in the vessel 101 and/or the sensor 107 in the recirculating flow of spirits in the piping system 110) by which the end-point of the process may be measured for and determined. For example, sensor signals overtime may be monitored until the sensor signals indicate the process end-point has been reached as illustrated in FIG. 2.

In various embodiments, a plurality of cartridges may be used singularly, or in combination, to create different recipe steps during the sequence of process time for the spirits 130. For example, a first cartridge (e.g., mStave 104) with a first air fraction may be exposed to a fraction of, or the bulk of, the flow during a first recipe step. A second cartridge (e.g., mStave 105) with a second air fraction may be exposed to a fraction of, or the bulk of, the flow during a second recipe step. A plurality of recipe steps may be processed in this fashion. Flow to and from the cartridges (e.g., mStave 104, mStave 105, and/or mStave 106) may be controlled by the one or more valves 112-117.

In various embodiments, the recirculation through the cartridges (e.g., mStave 104, mStave 105, and/or mStave 106) may be either 100% liquid spirits 130 or a two-phase flow of spirits 130 and oxygen containing gas, such as air 140 (or pure oxygen), etc.

In various embodiments, end-point measurement may be used by the controller 118 to determine when to shift from one recipe step (e.g., step N) to a next recipe step (e.g., step N+1) and/or for making changes in the line-up of micro-stave cartridges (e.g., mStave 104, mStave 105, and/or mStave 106) and spirits 130 to air 140 ratios or other process parameters at the time of that detected end-point.

In various embodiments, a sub-set plurality of the plurality of the cartridges (e.g., mStave 104, mStave 105, and/or mStave 106) may include some or all charcoal or similar adsorbing material to achieve the advantage of allowing recipe process steps to adsorb compounds from the spirits.

In various embodiments, a sub-set plurality of the plurality of the cartridges (e.g., mStave 104, mStave 105, and/or mStave 106) may include some or all catalyst material to trigger and accelerate reactions that improve flavor and or mouthfeel.

In various embodiments, one or more of the cartridges (e.g., mStave 104, mStave 105, and/or mStave 106) may be defined to create specific flavor elements. Recipe steps may then driven as per the required taste without requiring change of the cartridge (e.g., mStave 104, mStave 105, and/or mStave 106) composition. In one example, cartridge 1 (e.g., mStave 104) may be filled with 100% toasted micro-staves; cartridge 2 (e.g., mStave 105) may be filled with 100% charred micro-staves; and cartridge 3 (e.g., mStave 106) may be filled with charcoal filtration media. As additional examples, cartridges (e.g., mStave 104, mStave 105, and/or mStave 106) may be filled with un-toasted micro-staves, cartridges (e.g., mStave 104, mStave 105, and/or mStave 106) may be filled with other wood products, such as un-toasted wood material, wood powder (e.g., saw dust), etc., cartridges (e.g., mStave 104, mStave 105, and/or mStave 106) may be filled with combinations of toasted micro-staves, charred micro-staves, un-toasted micro-staves, and/or other wood products, etc. By controlling the time and fraction of flow through the discrete cartridges (e.g., through the three discrete cartridges mStave 104, mStave 105, and mStave 106), the effect of blending different amounts of micro-staves into a batch of micro-staves can be created. In embodiments in which cartridges (e.g., mStave 104, mStave 105, and/or mStave 106) are specifically associated with specific flavor elements, process qualification may be determined up front by selecting specific cartridges (e.g., mStave 104, mStave 105, and/or mStave 106) for specific flavor elements. Such cartridges (e.g., mStave 104, mStave 105, and/or mStave 106) may be repeatable cartridges that may be swapped out for one another. In various embodiments, micro-staves may be un-toasted. Un-toasted micro-staves may be formed from wood that is seasoned (e.g., left to dry for a specific time, such as 6-48 months). Un-toasted micro-staves may not be toasted or charred. In various embodiments, micro-staves may be toasted. Toasted micro-staves may be formed from wood that is toasted prior to forming the micro-staves. The wood may be seasoned or un-seasoned. In various embodiments, micro-staves may be charred. Charred micro-staves may be formed by charring toasted micro-staves and/or by charring un-toasted micro-staves. The cartridges (e.g., mStave 104, mStave 105, and/or mStave 106) may include various types of micro-staves therein.

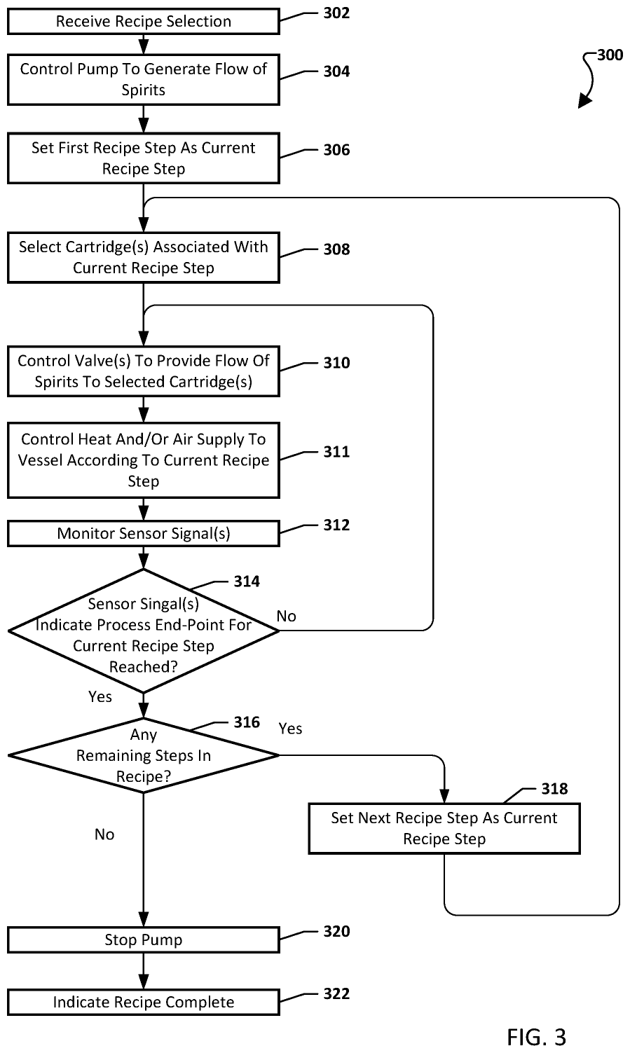

FIG. 3 illustrates a method 300 for maturing a flow of spirits (e.g., a flow of spirits 130) in accordance with various embodiments. With reference to FIGS. 1-3, the operations of method 300 may be performed by a controller (e.g., controller 118) of an in-line spirits processor (e.g., in-line spirits processor 100). The operations of method 300 may support spirit (e.g., spirit 130) maturation without stirring of the spirits during the maturation process.

In block 302, the controller may receive a recipe selection. In various embodiments, recipes may be a set of instructions (e.g., defined in hardware, software, and/or firmware, etc.) defining one or more recipe steps for processing spirits (e.g., spirits 130) to arrive at a desired process end-point. Recipes may be identified by a name, recipe identifier (ID), or other type indication. Recipes may be defined by a series of recipe steps each associated with one or more cartridges (e.g., mStave 104, mStave 105, and/or mStave 106) to be selected to receive a flow of spirits during the recipe step. Each recipe step may be associated with one or more end-points, such as temperature, times, pressures, rates, etc., that singularly, or in combination, may indicate when that respective recipe step is complete. Desired process end-points may be associated with desired aspects of the spirits when the end-point is achieved, such as color(s), flavor element(s), mouth feel(s), etc. Recipes may be stored in a memory available to the controller. The recipe selection may be received from a remote control terminal (e.g., remote control terminal 119) and/or a user interface of the controller, such as a display, keyboard, etc. The controller may load and/or otherwise retrieve a recipe corresponding to a received recipe selection.

In block 304, the controller may control a pump (e.g., pump 111) to generate a flow of spirits. In some embodiments, the flow rate of the pump may be variable. The activation of the pump may move spirits (e.g., spirits 130) out of a vessel (e.g., vessel 101), through a piping system (e.g., piping system 110), and back into the vessel.

In block 306, the controller may set a first recipe step as a current recipe step. In some embodiments, setting a recipe step may include setting one or more thresholds for sensor signals that correspond to one or more end-points, such as temperature, times, pressures, rates, etc., that singularly, or in combination, represent the completion of a desired maturation and/or other type change to the spirits (e.g., spirits 130) to be achieved during the recipe step.

In block 308, the controller may select one or more cartridges associated with the current recipe step. For example, the controller may select one or more cartridges (e.g., mStave 104, mStave 105, and/or mStave 106) to receive a flow of spirits during the step. As a specific example, the controller may select mStave 104 and mStave 105 to receive the flow of spirits during the first step of a recipe. Different recipes and/or different recipe steps may be associated with different combinations of one or more cartridges, such as different combinations of mStave 104, mStave 105, and/or mStave 106.

In block 310, the controller may control one or more valves (e.g., valves 112-117) to provide the flow of spirits to the one or more selected cartridges. For example, continuing with the example of selecting mStave 104 and mStave 105 to receive the flow of spirits during the first step, the controller may control valves 112, 113, 114, and 115 to transition to an open state.

In block 311, the controller may control the heat and/or air supply to the vessel according to the current recipe step. For example, the controller may control the heater 120 and/or valve 109 to input more or less heat and/or more or less air into a vessel (e.g., vessel 101).

In block 312, the controller may monitor one or more sensor signals. For example, the controller may receive signals from one or more sensors, such as sensors 102, 103, and/or 107. Additionally, or alternatively, the controller may also track the time for which the current recipe step has been occurring. Timing signals may be one of the one or more sensor signals received and/or the controller may track its own time counts via an internal clock/timer, such as a count-up timer, count-down timer, etc.

In determination block 314, the controller may determine whether the one or more sensor signals indicate a process end-point for the current recipe step is reached. The controller may be configured to correlate sensor signals with measurements and/or conditions associated with process end-points. The controller may compare the measurements and/or conditions determined based on sensor signals to process end-points associated with a current recipe step. A match to and/or passing of (e.g., falling below or rising above) a threshold may indicate an end-point for the current recipe step is reached. Recipe step end-points may be associated with desired aspects of the spirits, such as color(s), flavor element(s), mouth feel(s), etc.

In response to determining that the one or more sensor signals do not indicate a process end-point for the current recipe step is reached (i.e., determination block 314=“No”), the controller may continue to control the one or more valves to provide the flow of spirits to the one or more selected cartridges in block 310, control the heat and/or air supply to the vessel according to the current recipe step in block 311, and monitor one or more sensor signals in block 312. In this manner, the controller may apply continuous process controls to the one or more valves, heater, and/or air supply during the current recipe step until the monitored sensor signals indicate the end-point for the current recipe step is reached.

In response to determining that the one or more sensor signals do indicate a process end-point for the current recipe step is reached (i.e., determination block 314=“Yes”), the controller may determine whether there are any remaining steps in the recipe in determination block 316.

In response to determining that there is at least one remaining recipe step (i.e., determination block 316=“Yes”), the controller may set a next recipe step as a current recipe step in block 318. As a specific example, when the current step was the initial first step, the next step may be the second step in the recipe and that second step may be set as the new current step in block 318. The controller may proceed to select one or more cartridges associated with the next recipe step (now the current recipe step) in block 308, control the one or more valves to provide the flow of spirits to the one or more selected cartridges in block 310, control the heat and/or air supply to the vessel according to the next recipe step (now the current recipe step) in block 311, monitor one or more sensor signals in block 312, and determine whether the one or more sensor signals indicate a process end-point for the next recipe step (now the current recipe step) is reached in determination block 314. In this manner, the controller may apply continuous process controls to the one or more valves, heater, and/or air supply during the next recipe step (now the current recipe step) until the monitored sensor signals indicate the end-point for that next recipe step (now the current recipe step) is reached. In this manner, the steps of a recipe may be sequentially implemented by the controller until all the recipe steps are completed. For example, continuing with the example of selecting mStave 104 and mStave 105 to receive the flow of spirits during the first step, the second step, which may now be the current step, may have a different combination of cartridges associated with it (e.g., mStave 104 and mStave 106). In such an example, the controller may set control valves 114 and 115 to transition to a closed state, control valves 116 and 117 to transition to an open state, and may leave valves 112 and 113 in an open state such that the flow of spirits proceeds through mStave 104 and mStave 106 for the second (and now current) step.

In response to determining that there are no remaining recipe steps (i.e., determination block 316=“No”), the controller may stop the pump in block 320. Additionally, the various valves 109 and 112-117 may be opened and/or closed. No remaining recipe steps may indicate the spirits (e.g., spirits 130) have reached a desired end-point for the recipe and that desired end-point may be associated with desired aspects of the spirits, such as color(s), flavor element(s), mouth feel(s), etc.

In block 322, the controller may indicate the recipe is complete. For example, the controller may output an indication of the maturation being ready on a user interface of the controller and/or send an indication of the maturation being complete to a remote control terminal (e.g., remote control terminal 119).

Various examples, such as Examples A-P, are provided to illustrate aspects of the various embodiments. Example A: An in-line spirits processor, comprising: a vessel configured to hold spirits to be matured; a pump configured to recirculate a flow of the spirits from and to the vessel; and one or more cartridges in-line with the flow of spirits to be matured, at least one of the one or more cartridges including wood additives therein. Example B: The in-line spirits processor of Example A, wherein the wood additives comprise micro-staves. Example C: The in-line spirits processor of Example A or B, wherein the one or more cartridges are three cartridges. Example D: The in-line spirits processor of any of Examples A-C, wherein each of the one or more cartridges has a different composition of wood additive. Example E: The in-line spirits processor of any of Examples A-D, wherein the in-line spirits processor is configured to provide the flow of spirits to a first cartridge during a first recipe step and the flow of spirits to a second cartridge during a second recipe step. Example F: The in-line spirits processor of any of Examples A-E, wherein at least one of the one or more cartridges include charcoal. Example G: The in-line spirits processor of any of Examples A-F, wherein at least one of the one or more cartridges include catalyst material. Example H: The in-line spirits processor of any of Examples A-G, wherein the one or more cartridges are configured to create a specific flavor element in the spirits to be matured. Example I: A method for maturing a flow of spirits, comprising: providing spirits to be matured into a vessel of an in-line spirits processor; and recirculating a flow of the spirits from and to the vessel through one or more cartridges, at least one of the one or more cartridges including wood additives therein. Example J: The method of Example I, wherein the wood additives comprise micro-staves. Example K: The method of Example I or J, wherein each of the one or more cartridges has a different composition of wood additive. Example L: The method of any of Examples I-K, wherein recirculating the flow of the spirits from and to the vessel through the one or more cartridges comprises: providing the flow of spirits to a first cartridge during a first recipe step; and providing the flow of spirits to a second cartridge during a second recipe step. Example M: The method of any of Examples I-L, wherein at least one of the one or more cartridges include charcoal. Example N: The method of any of Examples I-M, wherein at least one of the one or more cartridges include catalyst material. Example O: The method of any of Examples I-N, further comprising stopping recirculation of the flow of the spirits from and to the vessel through the one or more cartridges in response to achieving a process end-point associated with a specific flavor element in the spirits to be matured. Example P: The in-line spirits processor of any of Examples A-H performing operations of any of the methods of Examples I-N.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect.

In an embodiment, the functions of one or more controllers of in-line spirits processor may be implemented in software, hardware, firmware, on any combination of the foregoing. In an embodiment, the hardware may include circuitry designed for implementing the specific functions of the one or more controllers of in-line spirits processor. In an embodiment, the hardware may include a programmable processing device configured with instructions to implement the functions of the one or more controllers of in-line spirits processor.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next.” etc. are not intended to limit the order of the steps; these words are simply used to guide the reader through the description of the methods.

One or more block/flow diagrams have been used to describe exemplary embodiments. The use of block/flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

Control elements may be implemented using computing devices (such as computer) comprising processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

What is claimed is:

1. An in-line spirits processor, comprising:
a vessel configured to hold spirits to be matured;
a pump configured to recirculate a flow of the spirits from and to the vessel; and
one or more cartridges in-line with the flow of spirits to be matured, at least one of the one or more cartridges including wood additives therein.

2. The in-line spirits processor of claim 1, wherein the wood additives comprise micro-staves.

3. The in-line spirits processor of claim 1, wherein the one or more cartridges are three cartridges.

4. The in-line spirits processor of claim 1, wherein each of the one or more cartridges has a different composition of wood additive.

5. The in-line spirits processor of claim 1, wherein the in-line spirits processor is configured to provide the flow of spirits to a first cartridge during a first recipe step and the flow of spirits to a second cartridge during a second recipe step.

6. The in-line spirits processor of claim 1, wherein at least one of the one or more cartridges include charcoal.

7. The in-line spirits processor of claim 1, wherein at least one of the one or more cartridges include catalyst material.

8. The in-line spirits processor of claim 1, wherein the one or more cartridges are configured to create a specific flavor element in the spirits to be matured.

9. A method for maturing a flow of spirits, comprising:
providing spirits to be matured into a vessel of an in-line spirits processor; and
recirculating a flow of the spirits from and to the vessel through one or more cartridges, at least one of the one or more cartridges including wood additives therein.

10. The method of claim 9, wherein the wood additives comprise micro-staves.

11. The method of claim 9, wherein each of the one or more cartridges has a different composition of wood additive.

12. The method of claim 9, wherein recirculating the flow of the spirits from and to the vessel through the one or more cartridges comprises:
providing the flow of spirits to a first cartridge during a first recipe step; and
providing the flow of spirits to a second cartridge during a second recipe step.

13. The method of claim 9, wherein at least one of the one or more cartridges include charcoal.

14. The method of claim 9, wherein at least one of the one or more cartridges include catalyst material.

15. The method of claim 9, further comprising stopping recirculation of the flow of the spirits from and to the vessel through the one or more cartridges in response to achieving a process end-point associated with a specific flavor element in the spirits to be matured.
